(19) United States
(12) Patent Application Publication
(10) Pub. No.: US 2016/0137214 A1
(43) Pub. Date: May 19, 2016

(54) Intelligent Wheelbarrow Apparatus

(71) Applicant: Thapelo Emmanuel Mkhize, Durban (ZA)

(72) Inventor: Thapelo Emmanuel Mkhize, Durban (ZA)

(21) Appl. No.: 14/754,754

(22) Filed: Jun. 30, 2015

Related U.S. Application Data
(60) Provisional application No. 62/079,836, filed on Nov. 14, 2014.

(51) Int. Cl. B62B 1/18; B62B 5/06

(52) U.S. Cl. CPC B62B 1/18; B62B 5/062

(57) ABSTRACT

An improved intelligent wheelbarrow apparatus is described. This improved intelligent wheelbarrow apparatus improves upon existing apparatus by easing the process of loading and off-loading objects into and out of the load bin. This process is eased by being able to lower the load bin to the ground so that objects can be rolled into the bin. This improves the user experience, by potentially reducing the number of workers needed to load or unload objects from a load bin, easing the strain on the human body by eliminating the need to lift heavy objects to any height, and reduces the risk of damaging the wheelbarrow or load by not needing to unload objects from any height.

### RELATED APPLICATION

This application claims the benefit of U.S. Provisional Patent Application Ser. No. 62/079,836 filed on Nov. 14, 2014.

### FIELD OF THE DISCLOSURE

The present disclosure relates generally to an improved intelligent wheelbarrow apparatus for yard-work, house-work, or construction applications. This improved intelligent wheelbarrow apparatus may also be usefully configured to work in various other arts beyond yard-work, house-work, or construction applications.

### BACKGROUND

The “conventional” wheelbarrow has proven to be one of the most successful and useful instruments known to man. Once a load has been loaded in the load bin of a wheelbarrow, the user simply applies a normal, vertical, force on the handle bars and pushes the load by applying a horizontal force.

However, the “conventional” wheelbarrow has significant drawbacks to its use at both the points of loading and offloading objects. For example, when loading heavy objects, such as a 50 Kg bag of cement, it would normally require two people to lift the object above the sides of the wheelbarrow, to a height of around 60 cm, and then lower it into the load bin of the wheelbarrow. This process creates a huge impediment for most people, as it is often impractical to assign to people to the task. Additionally, performing such lifting can have a harmful impact on the human torso's back.

The alternative method of loading the wheelbarrow involves tilting the wheelbarrow on its side, loading the object and then trying to return the wheelbarrow to its normal operating positon. The maneuver is difficult and dangerous. The wheel is also subjected to strains since the leading supporting leg ends up being loosened and damaged.

Offloading of heavy objects from “conventional” wheelbarrows also poses its own sets of challenges and difficulties. The most common method of unloading requires the user to raise the handle bars to such a height that the load is forced to fall out over the front wheel. This requires great human strength to lift the handle bars to such a height. In addition, during this process, the handle bar can slip from the user's grip and be damaged and fragile goods can be damaged by being dropped from a height over the front wheel.

There have been attempts over the years to improve upon the “conventional” wheelbarrow, including the Karrow Wheelbarrow, Folding Wheelbarrow, and Folding Garden Cart, but none have addressed the challenges pertaining to loading and offloading heavy objects.

The Karrow Wheelbarrow does not assist in lifting in loads by using handles for mechanical advantage, cannot lower load bin to ground level and its lightweight material may not be durable for industrial applications.

The Folding Wheelbarrow does not provide a mechanical advantage for lifting loads, is not durable because it is made from canvas materials and is not suitable for industrial applications including loading wet cement and boulders.

The Folding Garden Cart has no mechanical advantage provided for lifting loads, not easy to maneuver because it does not have one wheel and is not suitable for industrial applications including loading wet cement and boulders.

The issues described above are some of the reasons why there is a need for a wheelbarrow that eases the process of loading and offloading objects. Without an improved intelligent wheelbarrow apparatus, users will continue to struggle with loading heavy objects and continue to risk hurting themselves or damaging the wheelbarrow or loads.

Accordingly, there is a need for an improved intelligent wheelbarrow apparatus to assist users in the process of loading objects, so that a single user can more easily load heavy objects, and without great strain on their body. There is also a need for an improved intelligent wheelbarrow apparatus to assist in the process of offloading objects, so that great strength is not required by a user to lift the handlebars to tip out the load over the front wheel, and so that a user does not risk damaging the wheelbarrow or load in the process.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a system diagram of an improved intelligent wheelbarrow apparatus in its normal position, in accordance with some embodiments.

FIG. 2 is a system diagram of an improved intelligent wheelbarrow apparatus with its handles in its released position, in accordance with some embodiments.

FIG. 3 is a system diagram of an improved intelligent wheelbarrow apparatus ready to receive a load, in accordance with some embodiments.

FIG. 4 is a planning diagram showing various configurations of a locking mechanism.

FIG. 5 is a system diagram of an improved intelligent wheelbarrow apparatus showing another alternative design of the support cam.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The improved intelligent wheelbarrow apparatus addresses the issues of loading and offloading discussed above. It is designed to be constructed of mild steel, similar to the “conventional” wheelbarrow, but may also be made more robust so as to be used for industrial applications.

The overall design may be similar to the “conventional” wheelbarrow, in that may have a front wheel, bin, and handles. It may consist of handles which are associated with bin supports in the form of cams. The handles may be pivoted to the bin and moveable between a first, barrow-pushing, position, and a second position in which the handles may be raised and the cams allow the bin to assume a position which the trailing edge of the bin is at ground level for a loading or unloading operation. After loading the bin, the handles are then returned to their original position and the improved intelligent wheelbarrow apparatus is then ready to transport the goods—in a similar manner as that of the “conventional” wheelbarrow. The handles are secured to their original positions by virtue of locking clips that can be removably hooked and unhooked from the handle.

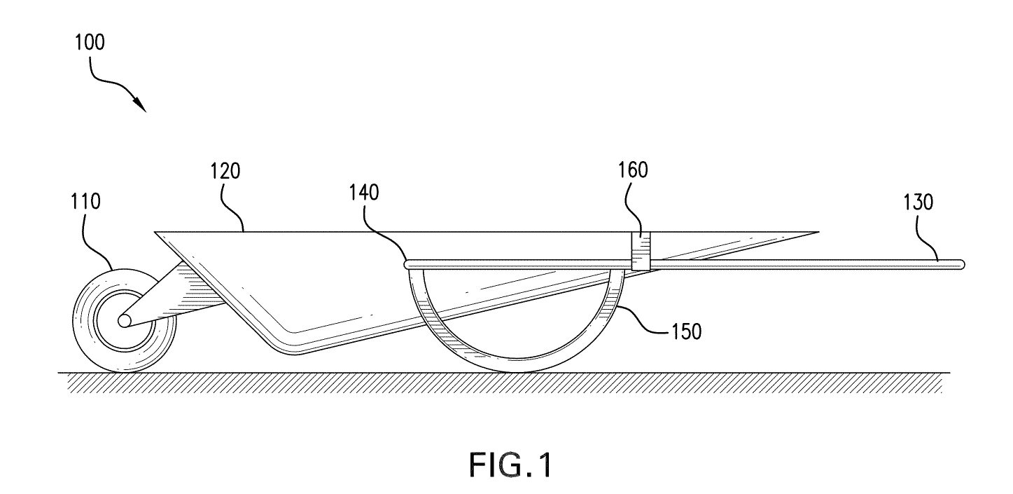

Turning to FIG. 1, shown is an embodiment of a diagrammatic side view of the improved intelligent wheelbarrow apparatus in its normal position 100. Included are a front wheel 110, load bin 120, handle 130, handle pivot point 140, support cam 150 and locking clip 160. The handles 130 have supporting cams 150 between the pivots 140 and the locking clips 160, and may be attached to the load bin 120 at the handle pivot point 140. The handles 130 are freed from the locking clip 160 by virtue of them being articulated at the handle pivot point 140 in a horizontal plane, thereby allowing the handles to be splayed for the raising operation. The locking clip 160 may be a fixed piece of mild steel bent to the shape of the handle bar. In this embodiment, the shape of the cam of the legs of the wheelbarrow is semicircular shaped.

Using Newton's third law of motion, the sum of all forces acting on the wheelbarrow are in equilibrium. From this law it follows that :

1) ΣFx=0; the sum of all horizontal forces (Fx) acting on the intelligent wheelbarrow are in equilibrium and equal to zero.

2) ΣFy=0; the sum of all vertical forces (Fy) acting on the intelligent wheelbarrow are in equilibrium and equal to zero.

From the above Newton's law, Ftx (horizontal force exerted by pushing wheelbarrow) is equal to the rolling resistance of the wheel Rx:

Ftx=Rx

From the above Newton's law, W (weight of wheelbarrow and the load) is equal to RA (vertical reaction at wheel) and Fty (vertical reaction at handle):

W=RA+Fty

The above force analysis of the intelligent wheelbarrow leads to the following conclusions:

To reduce Fty (force exerted by the user) the wheel position should be as close as possible to the center of mass W.

The reaction at the locking clips 160 is equal to the force exerted by the load W. Thus, the locking clips 160 that hold the handle bars must be securely attached to the side of the intelligent wheelbarrow as they pose a threat of being a possible failure point if they are not properly attached. The driving wheel should have a minimal rolling resistance so that the use of the intelligent wheelbarrow is effortless.

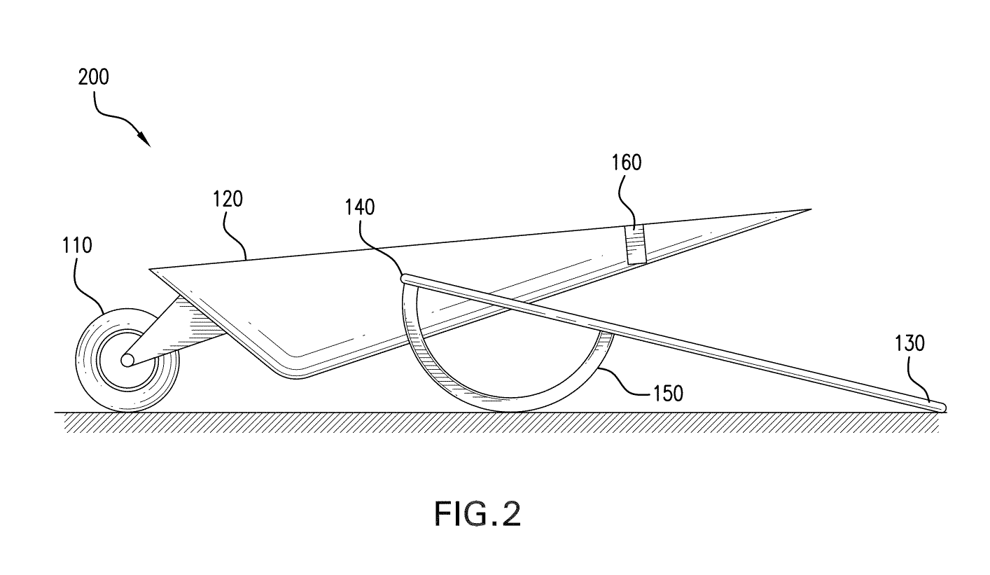

Turning to FIG. 2, shown is an embodiment of a diagrammatic side view of the improved intelligent wheelbarrow apparatus in a released position 200. Included are a front wheel 110, load bin 120, handle 130, handle pivot point 140, support cam 150, and locking clip 160. Here the handle 130 has been freed of the locking clip 160, and is in a state now in which the handles 140 may be raised, so that the load bin 120 may be lowered towards the ground.

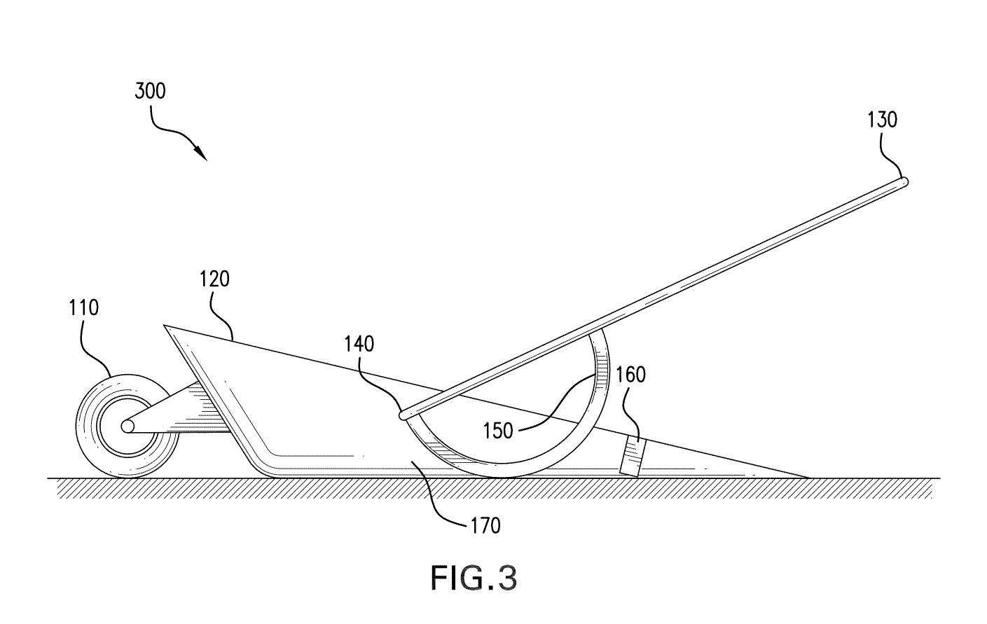

Turning to FIG. 3, shown is an embodiment of a diagrammatic side view of the improved intelligent wheelbarrow apparatus in a loading position 300. Included are a front wheel 110, load bin 120, handle 130, handle pivot point 140, support cam 150, locking clip 160 and rear edge 170. Here the load bin 120 lowering process has been completed. The handles 130 have been raised, and the rear edge 170 is now at ground level so that objects may be loaded into the load bin 120. The lowering process may be performed gradually, with the support cam 150 ensuring that the operation may be as smooth as possible. In this embodiment, the shape of the cam of the legs of the wheelbarrow is semi-circular. The objective is to have the rolling action of the legs be as smooth as possible.

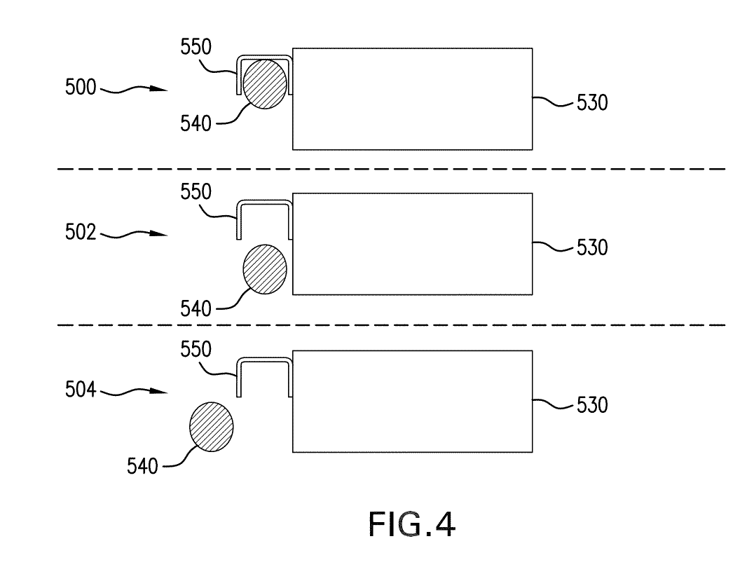

Turning to FIG. 4, shown is an apparatus diagram of 3 states of the locking pin viewed from the rear end. The locking clip 550 may be an upside-down U-shaped bracket attached to the load bin section 530. The attachment may occur via welding or other mechanisms. The handle bar 540 selectively is inserted and removed from the locking clip 550. In the first diagram 500, the handle bar 540 is locked into the locking clip 550. The handle 540 will be locked when it is guided into the locking clip 520 by the user of the wheelbarrow. To unlock the handle 540 from the locking clip 550, the user simply pushes the handle 540 downwards (at a possible length of about 60 mm) as shown in the second diagram. 502. Then, the user may move the handle 540 sideways (at a possible length of about 50 mm) as shown in the third diagram 504. This may be a purely mechanical operation without buttons, cables or springs.

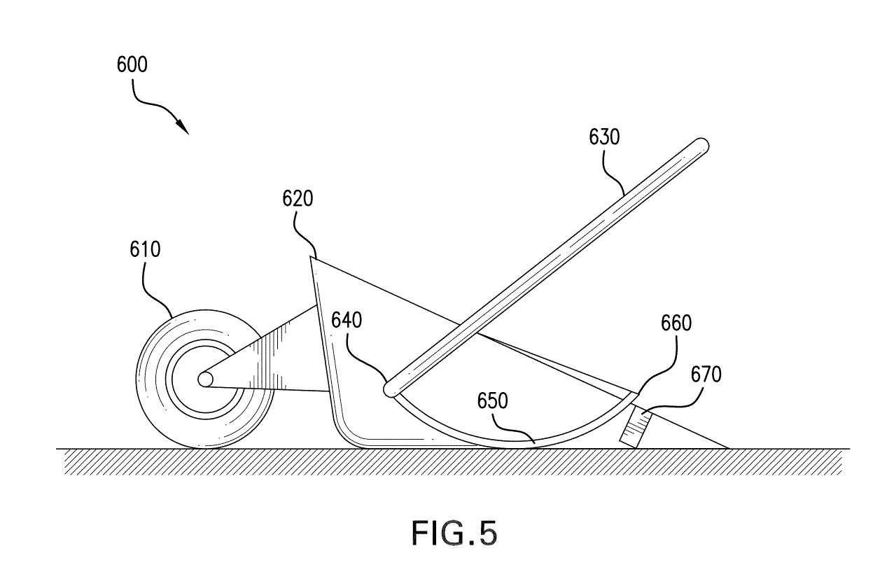

Turning to FIG. 5, shown is a diagrammatic side view of another embodiment 600 of an improved intelligent wheelbarrow apparatus with alternative cam support designs. Included are a front wheel 610, load bin 620, handle 630, handle pivot point 640, support cam 650, and rear edge 660 and locking clip 670. Here the load bin 620 lowering process has been completed. The handles 630 have been raised, and the rear edge 660 is now at ground level so that objects may be loaded into the load bin 620. The lowering process may be performed gradually, with the support cam 650 ensuring that the operation may be as smooth as possible. In this embodiment, the load bin 620 is approximately a similar size as the front wheel 610 such that it requires a smaller support cam 650. In this embodiment, the shape of the cam of the legs of the wheelbarrow is pie-slice shaped. The objective is to have the rolling action of the legs be as smooth as possible. The use of the locking clip mechanism 670 may be similar to that of the embodiments discussed above.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

I claim:

1. A wheelbarrow comprising:
a front wheel;
a load bin having a load bin left side and a load bin right side, wherein the load bin is mechanically engaged with front wheel;
a left support cam mechanically engaged with the load bin so that the left support cam selectively rotates about the load bin;
a right support cam mechanically engaged with the load bin so that the right support cam selectively rotates about the load bin;
a left handle having a left handle distal end and a left handle proximal end,
wherein the left handle distal end is attached to the left support cam and the left handle proximal end extends beyond the load bin in the direction away from the front wheel;
a right handle having a right handle distal end and a right handle proximal end,
wherein the right handle distal end is attached to the right support cam and the right handle proximal end extends beyond the load bin in the direction away from the front wheel;
a left clip attached to the left side load bin;
a right clip attached to the right side load bin;
wherein the left handle is selectively engageable and removable from the left clip; and
wherein the right handle is selectively engageable and removable from the right clip.

2. The wheelbarrow as in claim 1 wherein when the left handle is removed from the left clip and when the right handle is removed from the right clip, the left support cam and the right support cam are capable of rotating so that the load bin is lowered to near ground level.

3. The wheelbarrow as in claim 1, wherein when the left handle is lowered from the left clip and moved sideways away from the load bin left side and when the right handle is lowered from the right clip and moved sideways away from the load bin right side, the left support cam and the right support cam are capable of rotating so that the load bin is lowered to near ground level.

4. The wheelbarrow as in claim 1 wherein the left clip is substantially a “U” shape where the open part of the “U” shape is on the lower part of the left clip, and wherein the right clip is substantially a “U” shape where the open part of the “U” shape is on the lower part of the right clip.

5. The wheelbarrow as in claim 4, wherein the left handle is lowered from the left clip by a distance of approximately 60 mm and wherein the right handle is lowered from the right clip by a distance of approximately 60 mm.

6. The wheelbarrow as in claim 4, wherein the left handle is moved sideways from the left clip by a distance of approximately 50 mm and wherein the right handle is moved sideways from the right clip by a distance of approximately 50 mm.

7. The wheelbarrow as in claim 1, further comprising a load placed within the load bin.

8. The wheelbarrow as in claim 1 wherein the load bin is about the same size as the front wheel.

9. The wheelbarrow as in claim 1, wherein the left support cam and the right support cam are pie-slice shaped.

10. The wheelbarrow as in claim 1, wherein the left support cam and the right support cam are semicircular shaped.
